(19) United States
(12) Patent Application Publication
(10) Pub. No.: US 2020/0249055 A1
(43) Pub. Date: Aug. 6, 2020

(54) POSITION DETECTION METHOD, CONTROL METHOD, MANUFACTURING METHOD, POSITION DETECTION APPARATUS, ROBOT APPARATUS, OPTICAL DEVICE, AND NON-TRANSITORY RECORDING MEDIUM

(71) Applicant: CANON KABUSHIKI KAISHA, Tokyo (JP)

(72) Inventor: Haruhiko Horiguchi, Tokyo (JP)

(21) Appl. No.: 16/748,434

(22) Filed: Jan. 21, 2020

(30) Foreign Application Priority Data
Feb. 6, 2019 (JP) 2019-020133
Dec. 6, 2019 (JP) 2019-221663

(51) Int. Cl. G01D 5/347; B25J 13/08; G02B 7/02

(52) U.S. Cl. CPC G01D 5/34746; G02B 7/02; G01D 5/34776; B25J 13/088

(57) ABSTRACT

A position detection method includes obtaining a first phase value of a first signal that repetitively changes by a first cycle number, a second phase value of a second signal that repetitively changes by a second cycle number larger than the first cycle number, and a third phase value of a third signal that repetitively changes by a third cycle number larger than the second cycle number, selecting one cycle corresponding to the first phase value from cycles of the second cycle number, selecting one cycle corresponding to the second phase value and the cycle selected from the cycles of the second cycle number, obtaining a fourth phase value of the third signal corresponding to the second phase value of the cycle selected from the cycles of the second cycle number, and obtaining a position of the scale by using the third phase value and the fourth phase value.

### BACKGROUND OF THE INVENTION

### Field of the Invention

The present invention relates to a technique of detecting a position of a target object.

### Description of the Related Art

Generally, an encoder is known as a device for detecting a translational position or a rotational position of a measurement target object. There are optical encoders, magnetic encoders, and electrostatic capacitance encoders. Taking an optical encoder as an example, the encoder includes a light source, a scale that reflects or transmits the light emitted from the light source and is capable of being relatively displaced with respect to the light source, and a light receiving element that receives the light reflected by or transmitted through the scale. A pattern that reflects or transmits light is formed on the scale. The amount of light received by the light receiving element changes in accordance with the relative displacement of the scale. The light receiving element outputs a detection signal corresponding to the change in the amount of light. A processing apparatus that has received the input of the detection signal obtains the position of the scale on the basis of the detection signal.

Examples of the detection system of an optical encoder include an incremental system and an absolute system. The incremental system has a simpler structure. However, in the incremental system, the position information is lost when the power is turned off, and therefore the scale needs to be temporarily moved to a home position. In contrast, in the absolute system, the scale does not have to be moved to the home position even when the power is turned off.

Incidentally, there is a risk that the accuracy of the position information decreases as a result of foreign matter attaching to the scale, a scratch formed on the scale, or an externally originated noise. In Japanese Patent Laid-Open No. 2015-87193, a scale and a detection sensor are relatively moved, two pieces of absolute position information and two pieces of relative position information are obtained, and whether or not abnormality is found in the absolute position information is determined on the basis of whether or not the difference between the two pieces of absolute position information matches the difference between the two pieces of relative position information.

However, in Japanese Patent Laid-Open No. 2015-87193, the scale and the detection sensor need to be relatively moved a plurality of times for detecting the position information, which takes a long time. Therefore, in an apparatus that controls a control target object on the basis of the position information, control takes a long time.

### SUMMARY OF THE INVENTION

According to a first aspect of the present invention, a position detection method for a scale, the position detection method includes obtaining, by a processor and at the same position of the scale, a first phase value of a first signal that repetitively changes by a first cycle number per predetermined displacement of the scale, a second phase value of a second signal that repetitively changes by a second cycle number larger than the first cycle number per the predetermined displacement of the scale, and a third phase value of a third signal that repetitively changes by a third cycle number larger than the second cycle number per the predetermined displacement of the scale, selecting, by the processor, one cycle corresponding to the first phase value from cycles of the second cycle number in the second signal, selecting, by the processor and from cycles of the third cycle number in the third signal, one cycle corresponding to the second phase value and the cycle selected from the cycles of the second cycle number, obtaining, by the processor, a fourth phase value of the third signal corresponding to the second phase value of the cycle selected from the cycles of the second cycle number, and obtaining, by the processor, a position of the scale by using the third phase value and the fourth phase value.

According to a second aspect of the present invention, a position detection apparatus includes a processor, a scale, and a detection portion configured to output a signal corresponding to a position of the scale to the processor. the processor obtains, at the same position of the scale, a first phase value of a first signal that repetitively changes by a first cycle number per predetermined displacement of the scale, a second phase value of a second signal that repetitively changes by a second cycle number larger than the first cycle number per the predetermined displacement of the scale, and a third phase value of a third signal that repetitively changes by a third cycle number larger than the second cycle number per the predetermined displacement of the scale, selects, from cycles of the second cycle number in the second signal, one cycle corresponding to the first phase value, and, from cycles of the third cycle number in the third signal, one cycle corresponding to the second phase value and the cycle selected from the cycles of the second cycle number, obtains a fourth phase value of the third signal corresponding to the second phase value of the cycle selected from the cycles of the second cycle number, and obtains the position of the scale on a basis of the third phase value and the fourth phase value.

Further features of the present invention will become apparent from the following description of exemplary embodiments with reference to the attached drawings.

### BRIEF DESCRIPTION OF THE DRAWINGS

FIG. 1A is a schematic view of a position detection apparatus according to a first exemplary embodiment.

FIG. 1B is a plan view of a sensor unit according to the first exemplary embodiment.

FIG. 2A is a plan view of a part of a scale according to the first exemplary embodiment.

FIG. 2B is a plan view of a unit block pattern according to the first exemplary embodiment.

FIG. 3 is a plan view of a light receiving element array according to the first exemplary embodiment.

FIG. 4 is a plan view of the light receiving element array according to the first exemplary embodiment.

FIG. 5 is a circuit diagram of a signal processing circuit according to the first exemplary embodiment.

FIG. 6 is a flowchart of a position detection method according to the first exemplary embodiment.

FIG. 7 is a diagram for describing the position detection method according to the first exemplary embodiment.

FIG. 8 is a diagram for describing the position detection method according to the first exemplary embodiment.

FIG. 9A is a schematic view of a position detection apparatus according to a second exemplary embodiment.

FIG. 9B is a plan view of a sensor unit according to the second exemplary embodiment.

FIG. 10A is a plan view of a scale according to the second exemplary embodiment.

FIG. 10B is an enlarged view of a region enclosed by a broken line in FIG. 10A.

FIG. 11A is a plan view of a part of a scale according to a third exemplary embodiment.

FIG. 11B is a plan view of a unit block pattern according to the third exemplary embodiment.

FIG. 12 is a flowchart of a position detection method according to the third exemplary embodiment.

FIG. 13 is a diagram for describing the position detection method according to the third exemplary embodiment.

FIG. 14 is a diagram for describing the position detection method according to the third exemplary embodiment.

FIG. 15 is a graph showing experimental results of the third exemplary embodiment.

FIG. 16 is a diagram showing applicability corresponding to respective cycle numbers.

FIG. 17 is a perspective view of a robot apparatus according to a fourth exemplary embodiment.

FIG. 18A is a section view of one joint of a robot arm according to the fourth exemplary embodiment.

FIG. 18B is a side view of one joint of the robot arm according to the fourth exemplary embodiment.

FIG. 19 is a block diagram illustrating a control system of the robot apparatus according to the fourth exemplary embodiment.

FIG. 20A is a front view of a surveillance camera.

FIG. 20B is a side view of the surveillance camera.

### DESCRIPTION OF THE EMBODIMENTS

### First Exemplary Embodiment

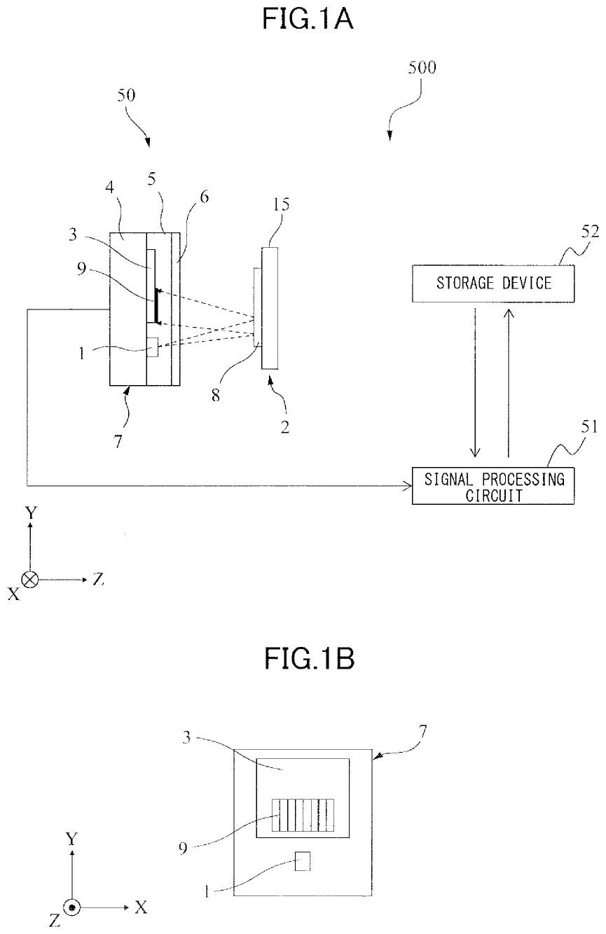

FIG. 1A is a schematic view of an encoder apparatus serving as an example of a position detection apparatus according to a first exemplary embodiment. An encoder apparatus 500 illustrated in FIG. 1A includes an encoder 50, a signal processing circuit 51 serving as an example of a processor, and a storage device 52 serving as an example of a storage portion. The encoder 50 is an optical encoder of an optical interference type. In addition, the encoder 50 is a reflective encoder. Further, the encoder 50 is a linear encoder of an absolute system.

The encoder 50 includes a scale 2 attached to one of a fixed portion and a movable portion, for example, the fixed portion, and a sensor unit 7 serving as an example of a detection portion that is attached to the other of the fixed portion and the movable portion, for example, the fixed portion, and disposed to oppose the scale 2. FIG. 1B is a plan view of the sensor unit 7. The scale 2 relatively translationally moves with respect to the sensor unit 7.

The movement direction of the scale 2 that relatively translationally moves with respect to the sensor unit 7 will be referred to as an X direction, a direction which is perpendicular to the X direction and in which the sensor unit 7 opposes the scale 2 will be referred to as a Z direction, and a width direction perpendicular to the X direction and the Z direction will be referred to as a Y direction.

The sensor unit 7 outputs a signal corresponding to the position of the scale 2 to the signal processing circuit 51. The signal processing circuit 51 performs interpolation calculation on the signal output from the sensor unit 7, writing and loading of signal data into and from the storage device 52, output of a signal indicating absolute position information of the scale 2, and so forth.

The sensor unit 7 includes a light source 1 constituted by a light emitting diode: LED and serving as an example of a light emitting unit, and a light receiving unit 3. The light receiving unit 3 includes a light receiving element array 9. The light source 1 and the light receiving unit 3 are mounted on a printed wiring board 4, and are sealed by a resin 5 that is transparent and transmits light. A glass 6 that is transparent and transmits light is disposed on the surface of the resin 5. According to this configuration, the light source 1 and the light receiving unit 3 are protected by the resin 5 and the glass 6.

The signal processing circuit 51 and the storage device 52 are each constituted by, for example, a semiconductor element constituted by an integrated circuit chip: IC chip, and mounted on the surface of the printed wiring board 4. To be noted, the installation positions of the signal processing circuit 51 and the storage device 52 are not limited to these, and these may be disposed at positions different from the surface of the printed wiring board 4. In FIG. 1A, the signal processing circuit 51 and the storage device 52 are illustrated at positions different from the surface of the printed wiring board 4 for the sake of convenience of description.

The scale 2 includes a substrate 15 and a scale track 8. The substrate 15 is formed from a material that has a relatively low reflectance of light and absorbs or transmits light, for example, glass. The scale track 8 is constituted by a member having a relatively high reflectance of light and formed on a main surface of the substrate 15 serving as an X-Y plane, for example, a chromium reflection film. In the description below, a portion having a relatively low reflectance of light in the scale track 8 will be referred to as a “non-reflection portion”, and a portion having a relatively high reflectance of light in the scale track 8 will be referred to as a “reflection portion”.

A light beam emitted from the light source 1 is radiated onto a part of the scale 2. The light beam radiated onto the scale 2 is reflected toward the light receiving element array 9, forms an image having a reflectance distribution doubled in size from the scale 2 on the light receiving element array 9, and is received by the light receiving element array 9. The light beam received by the light receiving element array 9 is photoelectrically converted and transmitted to the signal processing circuit 51 as an electric signal. The signal processing circuit 51 obtains absolute position information of a translational position on the basis of the received encoder signal, and outputs the absolute position information.

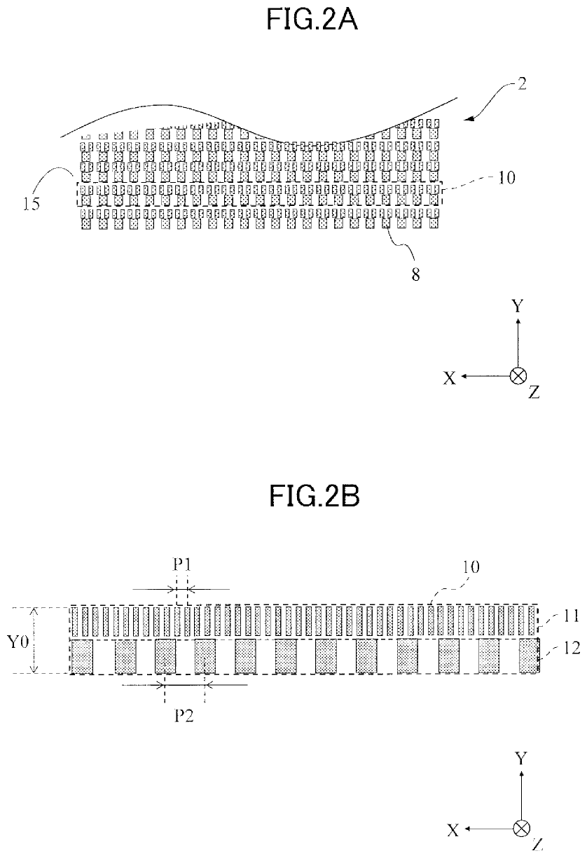

FIG. 2A is a plan view of a part of the scale 2. The scale track 8 is constituted by a plurality of unit block patterns 10 arranged in the Y direction on the main surface of the substrate 15. FIG. 2B is a plan view of one of the unit block patterns 10. The unit block pattern 10 includes a plurality of pattern rows 11 and 12 formed at different periods from each other. The plurality of pattern rows 11 and 12 are arranged in the Y direction.

In FIGS. 2A and 2B, shaded portions are reflection portions, and blank portions are non-reflection portions. In the pattern row 11, reflection portions are periodically arranged in the X direction at a pitch P1 serving as a modulation period in FIGS. 2A and 2B. In the pattern row 12, reflection portions are periodically arranged in the X direction at a pitch P2 serving as a modulation period different from the pitch P1 in FIGS. 2A and 2B. The pitch P1 is smaller than the pitch P2.

A width Y0 of the unit block pattern 10 in the Y direction is, for example, 50 μm. The pattern rows 11 and 12 each have a width of, for example, 25 μm in the Y direction. The pitch P1 is, for example, 129.074 μm. The pitch P2 is, for example, 580.833 μm. The total stroke, that is, the total length of each of the pattern rows 11 and 12 in the X direction is 2323.332 μm.

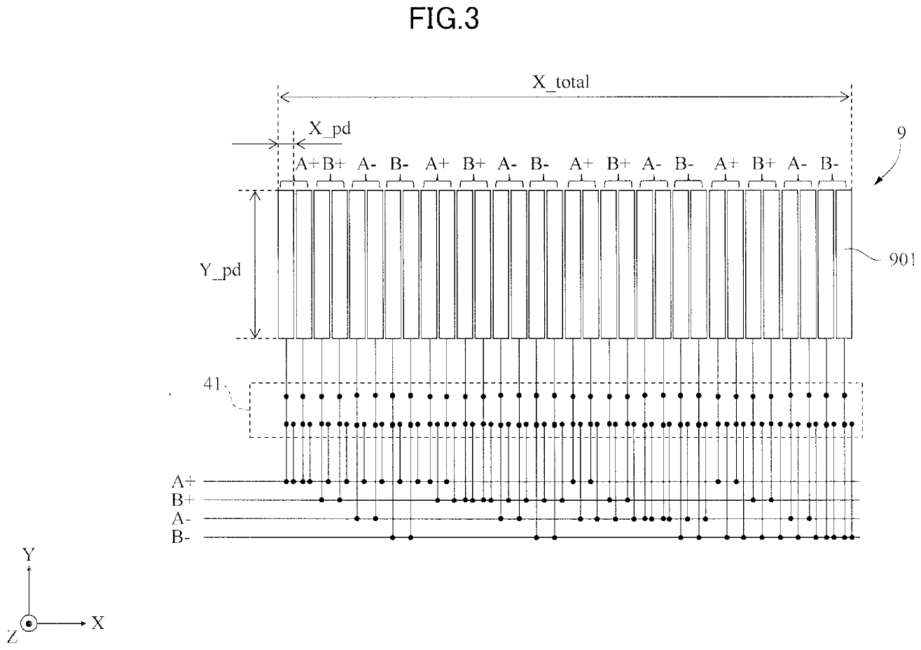

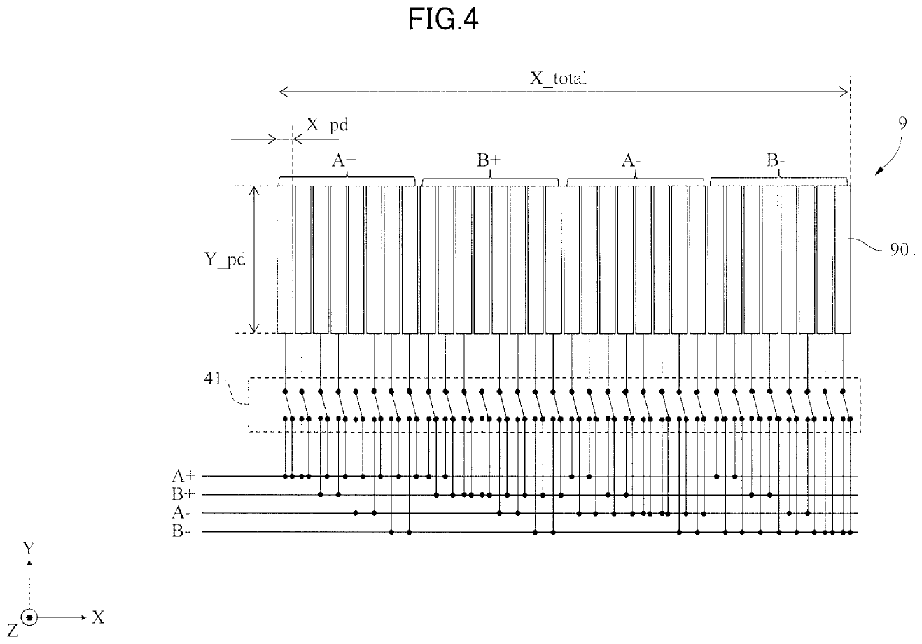

FIGS. 3 and 4 are each a plan view of the light receiving element array 9 according to the first exemplary embodiment. To be noted, in FIGS. 3 and 4, for the sake of convenience of description, part of elements of the signal processing circuit 51 of FIG. 1 are also illustrated. The light receiving element array 9 includes a plurality of, for example, 32 light receiving elements 901 arranged in the X direction. The plurality of light receiving elements 901 are arranged in the X direction at a pitch of, for example, 32 μm. The light receiving elements 901 each have a length X_pd in the X direction of, for example, 32 μm, and a length Y_pd in the Y direction of, for example, 800 μm. A total length X_total of the light receiving element array 9 in the X direction is, for example, 1024 μm.

As illustrated in FIG. 1A, the light source 1 and the light receiving element array 9 are arranged such that the height of a light emitting surface of the light source 1 in the Z direction is at the same level as the height of the light receiving surface of the light receiving element array 9 in the Z direction. According to this layout relationship, the pattern on the scale 2 is doubled in size as an enlarged projection image on the light receiving element array 9. Therefore, the radiation range of light radiated on the scale 2 is set to 400 μm in the Y direction and 512 μm in the X direction such that the reflection light from the scale 2 is incident on the entirety of the light receiving element array 9. An interference fringe derived from reflection light from the pattern row 11 among the scale track 8 and an interference fringe derived from reflection light from the pattern row 12 among the scale track 8 are both formed on the light receiving element array 9.

The signal processing circuit 51 illustrated in FIG. 1 includes a switch circuit 41 illustrated in FIGS. 3 and 4 that switches the resolution of positional information to be measured. The switch circuit 41 is constituted by a plurality of semiconductor switching elements. FIG. 3 illustrates a switching state of the switch circuit 41 in the case of measuring the position at a high resolution on the basis of the reflection light from the pattern row 11 of the scale track 8. FIG. 4 illustrates a switching state of the switch circuit 41 in the case of measuring the position at a low resolution on the basis of the reflection light from the pattern row 12 of the scale track 8.

By switching the switch circuit 41 as illustrated in FIG. 3, periodic signals corresponding to the pattern row 11 strengthen each other, and periodic signals corresponding to the pattern row 12 cancel each other. As a result of this, only periodic signals corresponding to the pattern row 11 can be obtained. In addition, by switching the switch circuit 41 as illustrated in FIG. 4, periodic signals corresponding to the pattern row 12 strengthen each other, and periodic signals corresponding to the pattern row 11 cancel each other. As a result of this, only periodic signals corresponding to the pattern row 12 can be obtained.

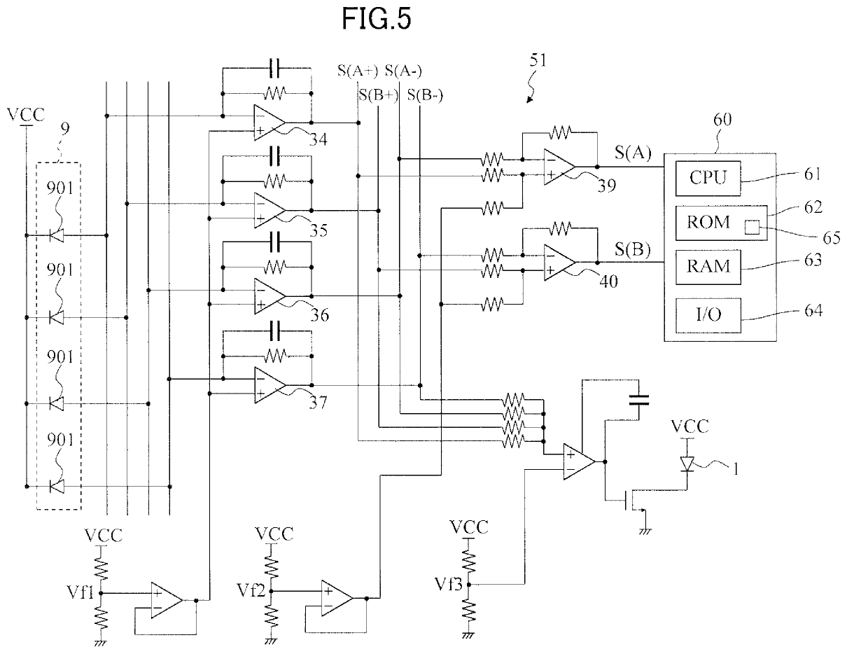

FIG. 5 is a circuit diagram of the signal processing circuit 51 according to the first exemplary embodiment. In FIG. 5, illustration of the switch circuit 41 is omitted, and, for the sake of convenience, only four of the light receiving elements 901 of the light receiving element array 9 connected to the signal processing circuit 51 are illustrated. The signal processing circuit 51 is illustrated as in FIG. 5 regardless of which of states of FIGS. 3 and 4 the switch circuit 41 is in.

Four I-V conversion amplifiers 34, 35, 36, and 37 that are first stage amplifiers are provided in a subsequent stage of the light receiving element array 9, that is, a subsequent stage of the switch circuit 41. An A-phase differential amplifier 39 and a B-phase differential amplifier 40 are provided in a subsequent stage of the I-V conversion amplifiers 34 to 37. A calculation circuit 60 constituted by, for example, a microcomputer, is provided in a subsequent stage of the A-phase differential amplifier 39 and the B-phase differential amplifier 40.

The calculation circuit 60 includes a central processing unit: CPU 61, a read only memory: ROM 62, a random access memory: RAM 63, and an I/O 64 that is an input/output interface. The ROM 62 stores a program 65 that causes the CPU 61 to perform each processing of a position detection method that will be described later.

To be noted, although a case where the ROM 62 serves as a computer-readable recording medium and the program 65 is stored in the ROM 62 will be described in the first exemplary embodiment, the configuration is not limited to this. The program 65 may be stored in any recording medium as long as the recording medium is computer-readable. Examples of the recording medium for supplying the program 65 include a flexible disk, a hard disk, an optical disk, a magneto-photo disk, a magnetic tape, and a nonvolatile memory. Examples of the optical disk include a digital versatile disk ROM: DVD-ROM, a compact disk ROM: CD-ROM, and CD-R. Examples of the nonvolatile memory include a universal serial bus memory: USB memory, a memory card, and a ROM.

The switch circuit 41 is capable of switching, according to an input signal from the calculation circuit 60, how a signal from the light receiving element array 9 is read out.

In the case where the input signal indicates a high level, the plurality of light receiving elements 901 are divided into pairs of two adjacent light receiving elements 901 as illustrated in FIG. 3. The respective pairs of the two adjacent light receiving elements 901 are electrically connected to corresponding ones of the I-V conversion amplifiers 34 to 37. Therefore, the measurement resolution is 128 μm. In the case where the input signal indicates a low level, the plurality of light receiving elements 901 are divided into groups of eight adjacent light receiving elements as illustrated in FIG. 4. The respective groups of the eight adjacent light receiving elements 901 are electrically connected to corresponding ones of the I-V conversion amplifiers 34 to 37. Therefore, the measurement resolution is 512 μm.

In the case where the input signal to the switch circuit 41 indicates a high level, only the periodic signals from the pattern row 11 of the scale track 8 can be obtained. In the case where the input signal to the switch circuit 41 indicates a low level, only the periodic signals from the pattern row 12 of the scale track 8 can be obtained. According to such a configuration, the light receiving element array 9 does not have to be individually provided for each of the pattern rows 11 and 12, thus the number of components can be reduced, and miniaturization of the encoder 50 can be realized.

Current signals read out from the respective light receiving elements 901 of the light receiving element array 9 are converted into sine wave voltage signals S(A+), S(B+), S(A−), and S(B−) of four phases in the I-V conversion amplifiers 34 to 37. The four phases will be referred to as an A+ phase, a B+ phase, an A− phase, and a B− phase, and the A+ phase will serve as a standard. The B+ phase, the A− phase, and the B− phase are respectively deviated by about +90°, about +180°, and about +270° from the A+ phase.

The sine wave voltage signals S(A+) and S(A−) of two phases are subjected to subtraction based on the formula (1) below in the A− phase differential amplifier 39. The sine wave voltage signals S(B+) and S(B−) of two phases are subjected to subtraction based on the formula (2) below in the B-phase differential amplifier 40.

S(A)=S(A+)−S(A−) (1)

S(B)=S(B+)−S(B−) (2)

As a result of this, an A-phase signal S(A) whose direct current component has been removed and a B-phase signal S(B) whose phase is deviated by 90° from the A-phase signal S(A) are generated.

Here, the pitch P1 and the pitch P2 are slightly different from the detection pitch of the light receiving element array 9. Therefore, the sine wave signals of two phases actually obtained from the scale track 8 are S(A)′ and S(B)′. In the present exemplary embodiment, processing of correcting a relative phase difference between the signals S(A)′ and S(B)′ is performed. A method of correcting the phase difference will be described below. Hereinafter, description will be given by taking a case of detecting the pitch P1 as an example.

The sine wave signals S(A′) and S(B)′ of two phases including an error e1 of relative phase difference are respectively represented by the formulae (3) and (4) below, in which θ represents the phase.

S(A)′=cos(θ+(e1)/2) (3)

S(B)′=sin(θ−(e1)/2) (4)

By adding and subtracting the sine wave signals S(A)′ and S(B)′ of two phases obtained by the formulae (3) and (4) as represented by the formulae (5) and (6) below, the error e1 can be separated.

S(A)′+S(B)′=2×cos(θ−π/4)sin((e1)/2−π/4) (5)

−S(A)′+S(B)′=2×sin(θ−π/4)cos((e1)/2−π/4) (6)

The error e1 can be expressed as e1=(1−128/129.074)×π by using design values. By respectively multiplying 2×sin((e1)/2−π/4) and 2×cos((e1)/2−π/4), which are amplitude components of the formulae (5) and (6), by inverse numbers thereof, the sine wave signals S(A) and S(B) of two phase in which the error e1 is corrected as represented by the formulae (7) and (8) below are calculated. To be noted, φ=θ−π/4 holds.

S(A)=(S(A)′+S(B)′)/(2×sin((e1)/2−π/4))=cos φ (7)

S(B)=(−S(A)′+S(B)′)/(2×cos((e1)/2−−π/4))=sin φ (8)

To be noted, the error e1 may be stored in the storage device 52 illustrated in FIG. 1 in an initialization operation. For example, an amplitude component 2×sin((e1)/2−π/4) is obtained from (maximum value−minimum vale)/2 of S(A)′+S(B)′ in a predetermined range in the X direction. In addition, an amplitude component 2×cos((e1)/2−π/4) is obtained from (maximum value−minimum vale)/2 of −S(A)′+S(B)′. Then, the error e1 may be obtained from these amplitude components, and stored in the storage device 52. In this case, correction can be performed in consideration of influence of the installation height difference between the light source 1 and the light receiving element array 9 and the error of image magnification derived from relative inclination of the scale 2 and the sensor unit 7. The same processing is also performed for the case of pitch P2 to obtain the signals S(A) and S(B). The following calculation of detecting the absolute position is performed by using the signals S(A) and S(B) obtained as described above.

First, a phase value Φ3 serving as phase information is obtained on the basis of the formula (9) below by using the signals S(A) and S(B) obtained by separating only the periodic signals of 128 μm in the case where the input to the switch circuit 41 indicates a high level.

Φ3=A TAN 2[S(A),S(B)] (9)

A TAN 2[Y, X] is an arctangent operation function of determining a quadrant and convert the quadrant into a phase of 0 to 2π.

Similarly, a phase value Φ2 serving as phase information is obtained on the basis of the formula (10) below by using the signals S(A) and S(B) obtained by separating only the periodic signals of 512 μm in the case where the input to the switch circuit 41 indicates a low level.

φ2=A TAN 2[S(A),S(B)] (10)

Further, by calculating the phase difference from the two phase values Φ2 and Φ3, Vernier operation of obtaining a periodic signal different from the original periodic signals is performed. That is, a phase value Φ1 serving as phase information is obtained by Vernier operation represented by the formula (11) below on the basis of the phase value Φ2 and the phase value Φ3.

Φ1=Φ3−4×Φ2 (11)

In the case where Φ1<0 holds, calculation of Φ1=Φ1+2π is performed to convert Φ1 into a value within an output range of 0 to 2πr. The period of the Vernier signal is the least common multiple of the pitch P1 of the pattern row 11 and the pitch P2 of the pattern row 12 illustrated in FIG. 2B. Therefore, the pitch P1 and the pitch P2 are set so as to achieve a desired Vernier period.

The phase values Φ1, Φ2, and Φ3 are each within the range of 0 to 2π [rad]. The signal processing circuit 51 obtains the position of the scale 2 by using the three phase values Φ1, Φ2, and Φ3.

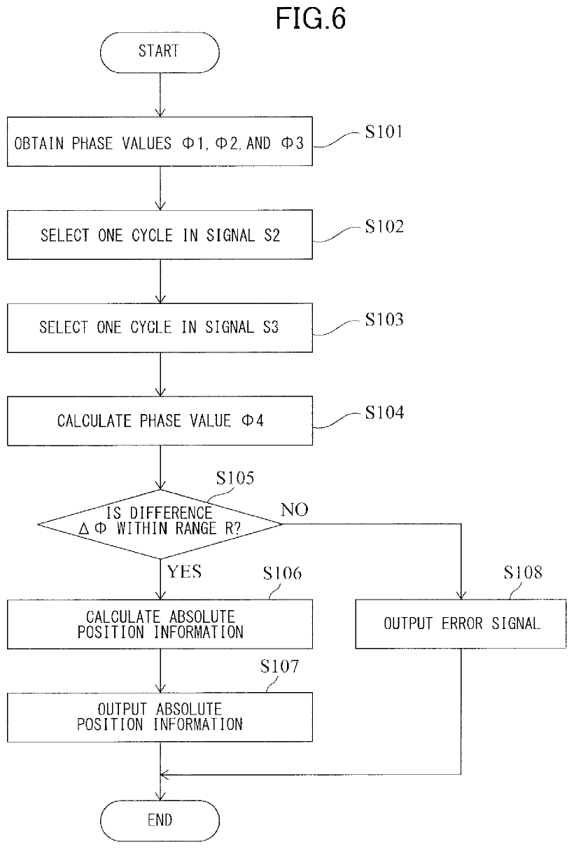

FIG. 6 is a flowchart of a position detection method according to the first exemplary embodiment. In step S101, the signal processing circuit 51 obtains the phase values Φ1, Φ2, and Φ3 by the arithmetic operation described above. The phase values Φ1, Φ2, and Φ3 are each a phase value at the same position of the scale 2.

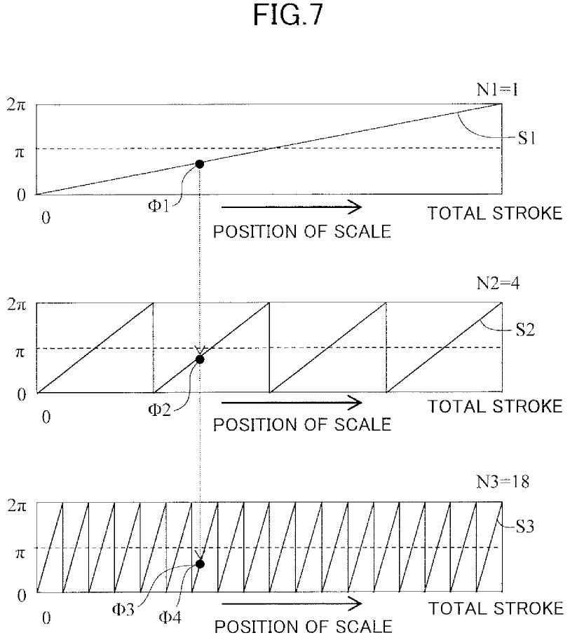

FIG. 7 is a diagram for describing the position detection method according to the first exemplary embodiment. FIG. 7 illustrates a relationship between each of the phase values Φ1, Φ2, and Φ3 and the position of the scale 2. The phase value Φ1 serving as a first phase value is a phase value of an upper signal S1 serving as a first signal and changes by one cycle in the total stroke of 2323.332 μm serving as an example of the predetermined displacement of the scale 2. The upper signal S1 is a Vernier signal. The phase value Φ2 serving as a second phase value is a phase value of a middle signal S2 serving as a second signal that is a periodic signal that repetitively changes by four cycles in the total stroke of the scale 2. The phase value Φ3 serving as a third phase value is a phase value of a lower signal S3 serving as a third signal that is a periodic signal that repetitively changes by 18 cycles in the total stroke of the scale 2.

That is, the upper signal S1 changes by a cycle number N1 serving as a first cycle number in the total stroke of the scale 2. The middle signal S2 changes by a cycle number N2 serving as a second cycle number larger than the cycle number N1 in the total stroke of the scale 2. The lower signal S3 changes by a cycle number N3 serving as a third cycle number larger than the cycle number N2 in the total stroke of the scale 2. In the present exemplary embodiment, the cycle number N1 is 1, the cycle number N2 is 4, the cycle number N3 is 18, and these are determined by the pitch P1 of the pattern row 11 and the pitch P2 of the pattern row 12 of the scale 2.

The relationships of the phases of the upper signal S1, the middle signal S2, and the lower signal S3 with the absolute position information in the total stroke are each measured in advance at the time of, for example, assembly of the encoder 50, and are stored in the storage device 52.

Although the position of the scale 2 can be determined from just the upper signal S1, the accuracy of the position determined in this manner is low. Therefore, in the present exemplary embodiment, the position of the scale 2 is obtained on the basis of the middle signal S2 having a higher resolution than the upper signal S1 and the lower signal S3 having a higher resolution than the middle signal S2.

In the middle signal S2, the only value obtained by the formula (10) above is the phase value Φ2, and which of the cycles of the cycle number N2 the position corresponds to is not obtained. Therefore, in step S102, the signal processing circuit 51 selects one cycle corresponding to the phase value Φ1 from the cycles of the cycle number N2 in the middle signal S2. For example, the signal processing circuit 51 obtains a provisional value of the position of the scale 2 from the phase value Φ1, and selects a cycle in the middle signal S2 including this provisional value. In the example of FIG. 7, the second cycle of the middle signal S2 is selected.

In the lower signal S3, the only value obtained by the formula (9) above is the phase value Φ3, and which of the cycles of the cycle number N3 the position corresponds to is not obtained. Therefore, in step S103, the signal processing circuit 51 selects one cycle corresponding to the phase value 2 and the cycle selected in step S102, that is, the second cycle among the cycles of the cycle number N2, from the cycles of the cycle number N3 in the lower signal S3. For example, the signal processing circuit 51 obtains a provisional value of the position of the scale 2 from the selected cycle and the phase value Φ2, and selects a cycle in the lower signal S3 including this provisional value. In the example of FIG. 7, the seventh cycle of the lower signal S3 is selected.

Incidentally, in the case where foreign matter such as a dust or grease attaches to the scale of the encoder, a scratch is formed on the scale, or an external noise is superimposed on the signal obtained from the encoder, an error is superimposed on the phase value Φ1 obtained by the formula (11). As a result of this, there is a possibility that the upper signal and the middle signal are not correctly synchronized. If the synchronization is incorrect, a detection position with low accuracy is output.

Therefore, the signal processing circuit 51 determines the synchronization accuracy. Specifically, first, in step S104, the signal processing circuit 51 calculates a phase value Φ4 serving as a fourth phase value by converting the phase value Φ2 into a phase value corresponding to the lower signal S3 in accordance with the cycle selected from the cycles of the cycle number N2. The signal processing circuit 51 converts the phase value Φ2 into the phase value Φ4 on the basis of the relationship of phase stored in the storage device 52.

In step S105, the signal processing circuit 51 obtains a difference ΔΦ between the phase value Φ3 and the phase value Φ4, and determines whether or not the difference ΔΦ is within a predetermined range R. ΔΦ indicates the synchronization accuracy, and is obtained by Φ4−Φ3 or Φ3−Φ4. The predetermined range R is a value stored in advance in the storage device 52, and is, for example, 0±α/4 [rad].

In the case where the difference ΔΦ is within the predetermined range R, that is, in the case where the result of step S105 is YES, the signal processing circuit 51 obtains, in step S106, absolute position information indicating the position of the scale 2, on the basis of the phase value Φ3 and the selected cycle, that is, the seventh cycle of the cycles of the cycle number N3. Since the relationship between the phase value Φ3 of the lower signal S3 that is in the range of 0 to 2π and the absolute position information of the scale 2 is stored in the storage device 52 in advance, the position of the scale 2 can be obtained by referring to the storage device 52. In step S107, the signal processing circuit 51 outputs the obtained absolute position information to an external device.

As described above and as illustrated in FIG. 7, by synchronizing the phase value Φ1 obtained by the formula (11), the phase value Φ2 obtained by the formula (10), and the phase value Φ3 obtained by the formula (9), the absolute position information of the scale 2 can be obtained. Further, by performing the synchronization evaluation of step S105, highly accurate absolute position information of the scale 2 can be obtained.

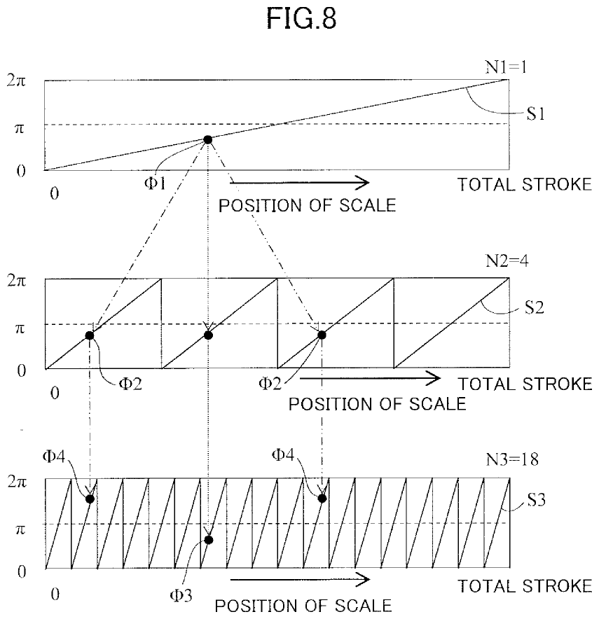

FIG. 8 is a diagram for describing a position detection method according the first exemplary embodiment. FIG. 8 illustrates respective relationships of the phase values Φ1, Φ2, and Φ3 with the position of the scale 2. In the example of FIG. 8, a case of correct synchronization and a case of incorrect synchronization between the upper signal S1 and the middle signal S2 are illustrated. For example, in the case of incorrect synchronization, synchronization is performed with a cycle deviated by one cycle from the correct cycle. The case of correct synchronization is indicated by dotted lines, and the case of incorrect synchronization is indicated by one-dot chain lines and two-dot chain lines. In the case where a foreign matter or a scratch is on the scale 2, incorrect synchronization is sometimes performed between the upper signal S1 and the middle signal S2.

For example, in the case where the phase value Φ1 has shifted to a higher value due to a foreign matter or the like, sometimes the signal processing circuit 51 may select, for example, an adjacent cycle, that is, the third cycle indicated by a two-dot chain line, in the synchronization processing between the upper signal S1 and the middle signal S2 in step S102. Conversely, in the case where the phase value Φ1 has shifted to a lower value, sometimes the signal processing circuit 51 may select, for example, an adjacent cycle, that is, the first cycle indicated by a one-dot chain line, in the synchronization processing between the upper signal S1 and the middle signal S2 in step S102. As described above, in the case where the synchronization is incorrect, the phase value Φ4 of the lower signal S3, which is 1.7π in this case, is deviated from the phase value Φ3, which is 0.7° in this case, beyond the predetermined range R. In the actuality, since a small error occurs in the phase value Φ3 of the lower signal S3 due to a pattern error of the scale 2, an interpolation error derived from high-frequency waves or the like, superimposition of a noise, or the like, the value of the predetermined range R is set in consideration of the error. In the present exemplary embodiment, in the case where the difference ΔΦ is out of the predetermined range R, that is, in the case where the result of step S105 is NO, the signal processing circuit 51 outputs an error signal in step S108.

As described above, in the first exemplary embodiment, whether or not the synchronization between the upper signal S1 and the middle signal S2 is incorrect can be determined. That is, in the case where the phase value Φ4 is deviated from the phase value Φ3, this fact can be confirmed from the error signal. It is thus determined that synchronization between the upper signal S1 and the middle signal S2 is incorrect. In this manner, by evaluating the phase value Φ3 of the lower signal S3, whether or not the synchronization between the upper signal S1 and the middle signal S2 is incorrect can be determined.

According to the first exemplary embodiment, since the synchronization evaluation of step S105 of FIG. 6 by the signal processing circuit 51 is performed on the basis the phase values Φ1 to Φ3, the time required for the position detection can be shortened while the synchronization evaluation is also performed. Therefore, time required for control can be also shortened in an apparatus that controls a control target object on the basis of the detected position information.

To be noted, whether or not the synchronization between the upper signal S1 and the middle signal S2 is incorrect may be also determined by evaluating the accuracy of synchronization between the middle signal S2 and the lower signal S3 on the basis of the phase value Φ3 of the lower signal S3. In the case where it is determined that the synchronization is incorrect, an error signal is issued, and therefore an unillustrated control apparatus that has received the error signal can stop subsequent operation related to the encoder apparatus 500.

In addition, although a case where the cycle number N1 of the upper signal S1 is 1, the cycle number N2 of the middle signal S2 is 4, and the cycle number N3 of the lower signal S3 is 18 in the total stroke of the scale 2 has been described, these values are mere examples, and not limited to the examples described above. A value N3/N2 obtained by dividing the cycle number N3 of the lower signal S3 by the cycle number N2 of the middle signal S2 may be any value that is not an integer, that is, a value with a non-zero fraction part. In the example described above, N3/N2 is 18/4=4.50.

As long as the upper signal S1 has a cycle number of 1 and the ratio N3/N2 between the cycle numbers of the lower signal S3 and the middle signal S2 is a value with a non-zero fraction part, occurrence of erroneous detection can be confirmed by issuing an error signal from the signal processing circuit 51 in the case where the difference ΔΦ is out of the predetermined range R.

Although the relationship between the three periodic signals of the upper signal, middle signal, and lower signal has been described in the first exemplary embodiment, the configuration is not limited to this. The present disclosure can be applied to a case where three or more periodic signals having different cycle numbers are obtained. That is, the processing described in the first exemplary embodiment may be performed on three consecutive periodic signals having a relationship of upper, middle, and lower signals among the three or more periodic signals. For example, periodic signals of 1 cycle, 4 cycles, 18 cycles, and 99 cycles per the total stroke may be obtained. In this case, whether or not the synchronization between the periodic signals of 4 cycles and 18 cycles is incorrect can be determined by evaluating the phase value of the periodic signal of 99 cycles. As described above, in an absolute encoder that obtains absolute position information, whether or not the synchronization between the middle periodic signal and upper periodic signal is incorrect can be confirmed by evaluating the phase value of the lower periodic signal in the three periodic signals.

### Second Exemplary Embodiment

In the first exemplary embodiment, a case where the pattern row 11 having the pitch P1 and the pattern row 12 having the pitch P2 are alternately arranged in the Y direction, and the resolution is switched by receiving the reflection light from the respective pattern rows 11 and 12 on the single light receiving element array 9 and switching the reflection light by the switch circuit 41 has been described. However, the configuration is not limited to this.

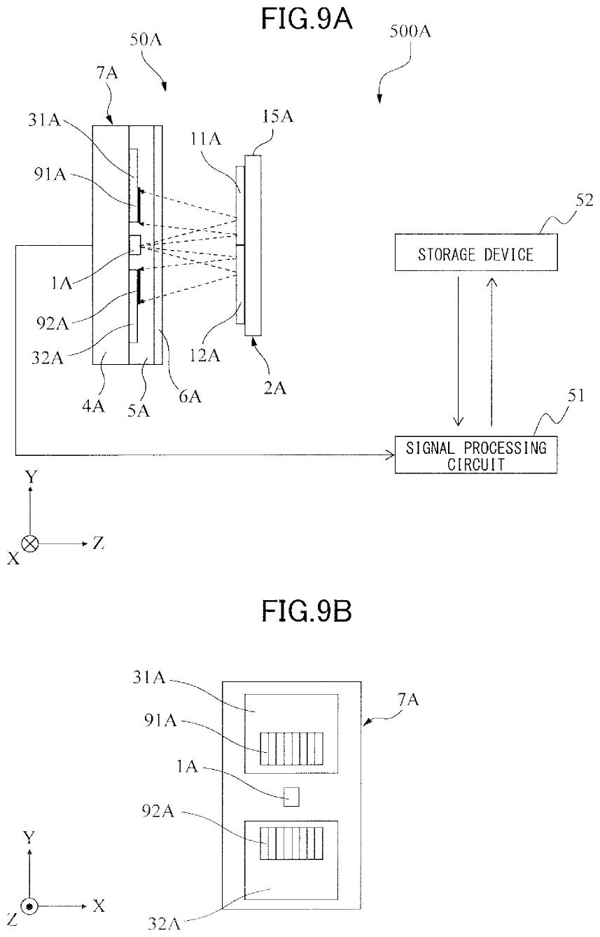

FIG. 9A is a schematic view of an encoder apparatus serving as an example of a position detection apparatus according to a second exemplary embodiment. To be noted, in the description below, elements similar to those described in the first exemplary embodiment are denoted by the same reference signs, and detailed description thereof is omitted.

An encoder apparatus 500A illustrated in FIG. 9A includes an encoder 50A, the signal processing circuit 51 serving as an example of a processor, and the storage device 52 serving as an example of a storage portion. The encoder 50A is an optical encoder of an optical interference type. In addition, the encoder 50A is a reflective encoder. Further, the encoder 50A is a linear encoder of an absolute system.

The encoder 50A includes a scale 2A, and a sensor unit 7A serving as an example of a detection portion disposed to oppose the scale 2A. FIG. 9B is a plan view of the sensor unit 7A. The scale 2A relatively translationally moves with respect to the sensor unit 7A.

The sensor unit 7A outputs a signal corresponding to the position of the scale 2A to the signal processing circuit 51. The signal processing circuit 51 performs interpolation calculation on the signal output from the sensor unit 7A, writing and loading of signal data into and from the storage device 52, output of a signal indicating absolute position information of the scale 2A, and so forth.

The sensor unit 7A includes a light source 1A constituted by a light emitting diode: LED and serving as an example of a light emitting unit, and two light receiving units 31A and 32A. The light receiving unit 31A includes a light receiving element array 91A. The light receiving unit 32A includes a light receiving element array 92A. The light source 1A and the light receiving units 31A and 32A are mounted on a printed wiring board 4A, and are sealed by a resin 5A that is transparent and transmits light. A glass 6A that is transparent and transmits light is disposed on the surface of the resin 5A. According to this configuration, the light source 1A and the light receiving units 31A and 32A are protected by the resin 5A and the glass 6A.

The scale 2A includes a substrate 15A formed from, for example, glass, and pattern rows 11A and 12A constituted by a member having a relatively high reflectance, for example, a chromium reflection film, and formed on the main surface, that is, X-Y plane of the substrate 15A.

A light beam emitted from the light source 1A is radiated onto a part of the scale 2A. A light beam radiated onto the pattern row 11A of the scale 2A is reflected toward and received by the light receiving element array 91A. The light beam received by the light receiving element array 91A is photoelectrically converted and transmitted to the signal processing circuit 51 as an electric signal. A light beam radiated onto the pattern row 12A of the scale 2A is reflected toward and received by a light receiving element array 92A. The light beam received by the light receiving element array 92A is photoelectrically converted and transmitted to the signal processing circuit 51 as an electric signal. The signal processing circuit 51 obtains absolute position information of a translational position on the basis of the received encoder signal, and outputs the absolute position information.

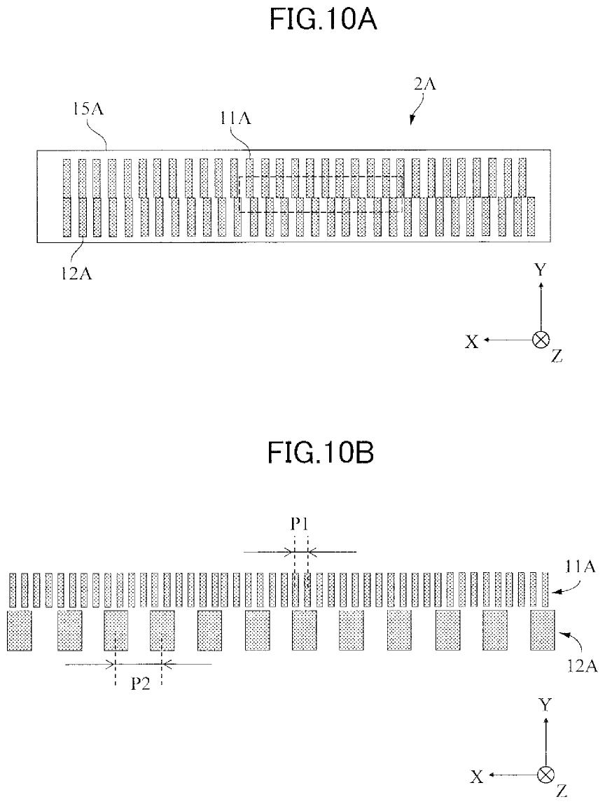

FIG. 10A is a plan view of a part of the scale 2A according to the second exemplary embodiment. The scale 2A includes pattern rows 11A and 12A arranged in the Y direction on the main surface of the substrate 15A. FIG. 10B is an enlarged view of a region enclosed by a broken line in FIG. 10A. In FIGS. 10A and 10B, shaded portions are reflection portions, and blank portions are non-reflection portions. In the pattern row 11A, as illustrated in FIG. 10B, reflection portions are periodically arranged in the X direction at a pitch P1 serving as a modulation period. In the pattern row 12A, reflection portions are periodically arranged in the X direction at a pitch P2 serving as a modulation period different from the pitch P1. The pitch P1 is smaller than the pitch P2. The light receiving element array 91A has a detection pitch corresponding to the pattern row 11A, and the light receiving element array 92A has a detection pitch corresponding to the pattern row 12A. As a result of this, the light receiving element arrays 91A and 92A illustrated in FIGS. 9A and 9B separately output detection signals of different resolutions.

The values of the pitches P1 and P2 are the same as the values described in the first exemplary embodiment. Therefore, the values obtained by the formulae (1) to (11) are also the same. In the second exemplary embodiment, whether or not the synchronization between the upper signal and the middle signal is incorrect can be determined by evaluating the phase value of the lower signal on the basis of the values thus obtained similarly to the first exemplary embodiment.

### Third Exemplary Embodiment

A position detection method according to the third exemplary embodiment will be described. In an encoder of the third exemplary embodiment, the configuration of the sensor unit is the same as that of the encoder of the first exemplary embodiment, and therefore the description thereof will be omitted. In the third exemplary embodiment, the configuration of the scale is different from that of the scale of the first exemplary embodiment. That is, in the encoder apparatus of the third exemplary embodiment, elements other than the scale are the same as in the first exemplary embodiment illustrated in FIGS. 1A and 1B. In addition, in the third exemplary embodiment, the position detection method for the scale is different from the first exemplary embodiment.

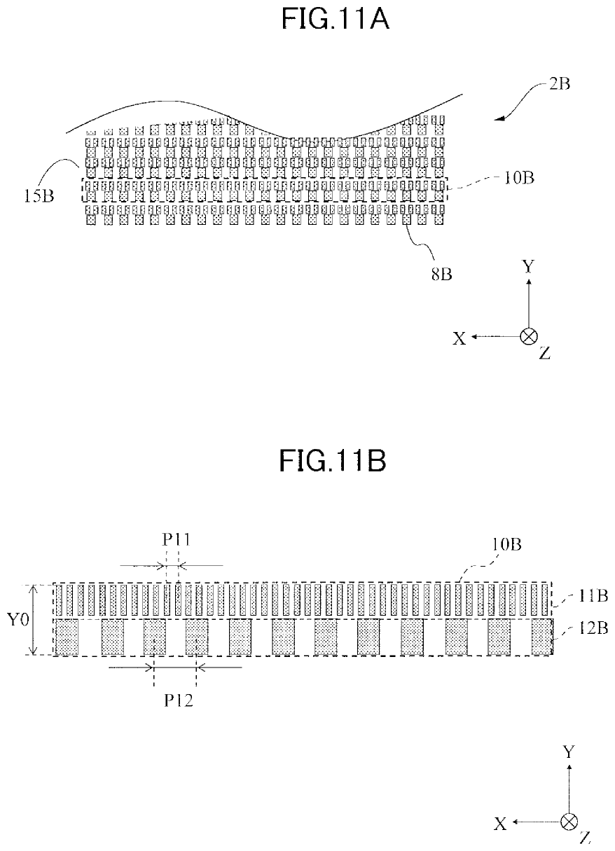

FIG. 11A is a plan view of a part of a scale 2B according to the third exemplary embodiment. The scale 2B of the third exemplary embodiment includes a substrate 15B formed from glass or the like and a scale track 8B formed on the substrate 15B. The scale track 8B is constituted by a plurality of unit block patterns 10B arranged in the Y direction on the main surface of the substrate 15B. FIG. 11B is a plan view of one of the unit block patterns 10B. The unit block pattern 10B includes a plurality of pattern rows 11B and 12B formed at different periods from each other. The plurality of pattern rows 11B and 12B are arranged in the Y direction.

In FIGS. 11A and 11B, shaded portions are reflection portions, and blank portions are non-reflection portions. In the pattern row 11B, reflection portions are periodically arranged in the X direction at a pitch P11 serving as a modulation period in FIGS. 11A and 11B. In the pattern row 12B, reflection portions are periodically arranged in the X direction at a pitch P12 serving as a modulation period different from the pitch P11 in FIGS. 11A and 11B. The pitch P11 is smaller than the pitch P12.

A width Y0 of the unit block pattern 10B in the Y direction is, for example, 50 μm. The pattern rows 11B and 12B each have a width of, for example, 25 μm in the Y direction. The pitch P11 is, for example, 129.074 μm. The pitch P12 is, for example, 548.5645 μm. The total stroke, that is, the total length of each of the pattern rows 11B and 12B in the X direction is 2194.258 μm.

Similarly to the first exemplary embodiment, the sensor unit reads the scale 2B, and thus the signal processing circuit 51 obtains the signals S(A) and S(B) and performs the following calculation for detecting the absolute position of the scale 2B.

First, a phase value φ13 serving as phase information is obtained on the basis of the formula (12) below by using the signals S(A) and S(B) obtained by separating only the periodic signals of 128 μm in the case where the input to the switch circuit 41 illustrated in FIG. 3 indicates a high level.

Φ13=A TAN 2[S(A),S(B)] (12)

A TAN 2[Y, x] is an arctangent operation function of determining a quadrant and convert the quadrant into a phase of 0 to 2π.

Similarly, a phase value Φ12 serving as phase information is obtained on the basis of the formula (13) below by using the signals S(A) and S(B) obtained by separating only the periodic signals of 512 μm in the case where the input to the switch circuit 41 illustrated in FIG. 4 indicates a low level.

Φ12=A TAN 2[S(A),S(B)] (13)

Further, by calculating the phase difference from the two phase values Φ12 and Φ13, Vernier operation for obtaining a periodic signal different from the original periodic signals is performed. That is, a phase value Φ11 serving as phase information is obtained by Vernier operation of the formula (14) below on the basis of the phase value Φ12 and the phase value Φ13.

Φ11=Φ13−4×Φ12 (14)

In the case where Φ11<0 holds, calculation of Φ11=Φ11+2π is performed to convert Φ11 into a value within an output range of 0 to 2π. The period of the Vernier signal is the least common multiple of the pitch P11 of the pattern row 11B and the pitch P12 of the pattern row 12B illustrated in FIG. 11B. Therefore, the pitch P11 and the pitch P12 are set so as to achieve a desired Vernier period.

The phase values Φ11, Φ12, and Φ13 are each within the range of 0 to 2π [rad]. The signal processing circuit 51 obtains the position of the scale 2B by using the three phase values Φ11, Φ12, and Φ13.

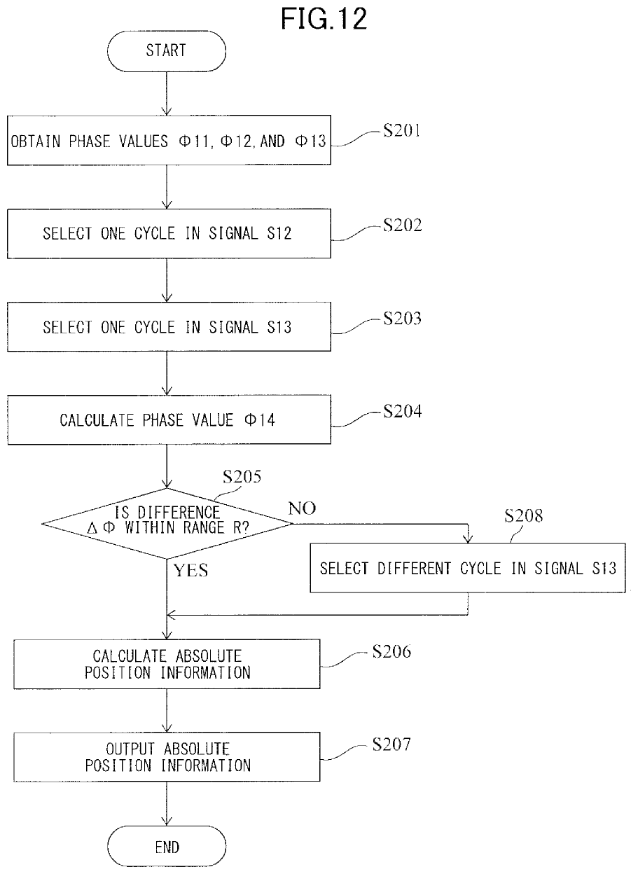

FIG. 12 is a flowchart of a position detection method according to the third exemplary embodiment. In step S201, the signal processing circuit 51 illustrated in FIG. 1A obtains the phase values Φ11, Φ12, and Φ13 by the arithmetic operation described above. The phase values Φ11, Φ12, and Φ13 are each a phase value at the same position of the scale 2B.

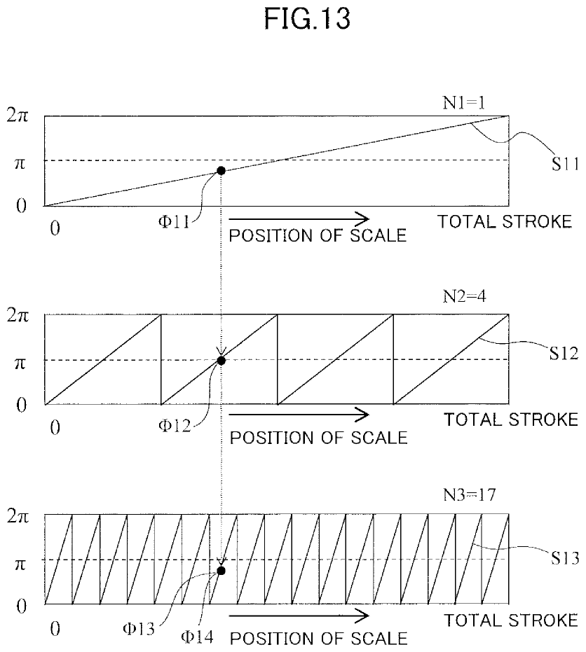

FIG. 13 is a diagram for describing the position detection method according to the third exemplary embodiment. FIG. 13 illustrates a relationship between each of the phase values Φ11, Φ12, and Φ13 and the position of the scale 2B. The phase value Φ11 serving as a first phase value is a phase value of an upper signal S11 serving as a first signal and changes by one cycle in the total stroke of 2194.256 μm serving as an example of the predetermined displacement of the scale 2B. The upper signal S11 is a Vernier signal. The phase value Φ12 serving as a second phase value is a phase value of a middle signal S12 serving as a second signal that is a periodic signal that repetitively changes by four cycles in the total stroke of the scale 2B. The phase value Φ13 serving as a third phase value is a phase value of a lower signal S13 serving as a third signal that is a periodic signal that repetitively changes by 17 cycles in the total stroke of the scale 2B.

That is, the upper signal S11 changes by a cycle number N1 serving as a first cycle number in the total stroke of the scale 2B. The middle signal S12 changes by a cycle number N2 serving as a second cycle number larger than the cycle number N1 in the total stroke of the scale 2B. The lower signal S13 changes by a cycle number N3 serving as a third cycle number larger than the cycle number N2 in the total stroke of the scale 2B. In the present exemplary embodiment, the cycle number N1 is 1, the cycle number N2 is 4, the cycle number N3 is 17, and these are determined by the pitch P11 of the pattern row 11B and the pitch P12 of the pattern row 12B of the scale 2B.

The relationships of the phases of the upper signal S11, the middle signal S12, and the lower signal S13 with the absolute position information in the total stroke are each measured in advance at the time of, for example, assembly of the encoder, and are stored in the storage device 52 illustrated in FIG. 1A.

Although the position of the scale 2B can be determined from just the upper signal S11, the accuracy of the position determined in this manner is low. Therefore, in the present exemplary embodiment, the position of the scale 2B is obtained on the basis of the middle signal S12 having a higher resolution than the upper signal S11 and the lower signal S13 having a higher resolution than the middle signal S12.

In the middle signal S12, the only value obtained by the formula (13) above is the phase value Φ12, and which of the cycles of the cycle number N2 the position corresponds to is not obtained. Therefore, in step S202, the signal processing circuit 51 illustrated in FIG. 1A selects one cycle corresponding to the phase value Φ11 from the cycles of the cycle number N2 in the middle signal S12. For example, the signal processing circuit 51 obtains a provisional value of the position of the scale 2B from the phase value Φ11, and selects a cycle in the middle signal S12 including this provisional value. In the example of FIG. 13, the second cycle of the middle signal S12 is selected.

In the lower signal S13, the only value obtained by the formula (12) above is the phase value Φ13, and which of the cycles of the cycle number N3 the position corresponds to is not obtained. Therefore, in step S203, the signal processing circuit 51 selects one cycle corresponding to the phase value Φ12 and the cycle selected in step S202, that is, the second cycle among the cycles of the cycle number N2, from the cycles of the cycle number N3 in the lower signal S13. For example, the signal processing circuit 51 obtains a provisional value of the position of the scale 2B from the selected cycle and the phase value Φ12, and selects a cycle in the lower signal S13 including this provisional value. In the example of FIG. 13, the seventh cycle of the lower signal S13 is selected.

Incidentally, in the case where foreign matter such as a dust or grease attaches to the scale of the encoder, a scratch is formed on the scale, or an external noise is superimposed on the signal obtained from the encoder, an error is superimposed on the phase value Φ11 obtained by the formula (14). As a result of this, there is a possibility that the upper signal and the middle signal are not correctly synchronized. If the synchronization is incorrect, a detection position with low accuracy is output.

Therefore, the signal processing circuit 51 determines the synchronization accuracy.

Specifically, first, in step S204, the signal processing circuit 51 calculates a phase value Φ14 serving as a fourth phase value by converting the phase value Φ12 into a phase value corresponding to the lower signal S13 in accordance with the cycle selected from the cycles of the cycle number N2. The signal processing circuit 51 converts the phase value Φ12 into the phase value Φ14 on the basis of the relationship of phase stored in the storage device 52.

In step S205, the signal processing circuit 51 obtains a difference MD between the phase value Φ13 and the phase value Φ14, and determines whether or not the difference ΔΦ is within a predetermined range R. ΔΦ indicates the synchronization accuracy, and is represented by Φ14−Φ13 or Φ13−Φ14. The predetermined range R is a value stored in advance in the storage device 52, and is, for example, 0±π/4 [rad].

In the case where the difference ΔΦ is within the predetermined range R, that is, in the case where the result of step S205 is YES, the signal processing circuit 51 obtains, in step S206, absolute position information indicating the position of the scale 2B, on the basis of the phase value Φ13 and the selected cycle, that is, the seventh cycle of the cycles of the cycle number N3. Since the relationship between the phase value Φ13 of the lower signal S13 that is in the range of 0 to 2π and the absolute position information of the scale 2B is stored in the storage device 52 in advance, the position of the scale 2B can be obtained by referring to the storage device 52. In step S207, the signal processing circuit 51 outputs the obtained absolute position information to an external device.

As described above and as illustrated in FIG. 13, by synchronizing the phase value Φ11 obtained by the formula (14), the phase value Φ12 obtained by the formula (13), and the phase value Φ13 obtained by the formula (12), the absolute position information of the scale 2B can be obtained. Further, by performing the synchronization evaluation of step S205, highly accurate absolute position information of the scale 2B can be obtained.

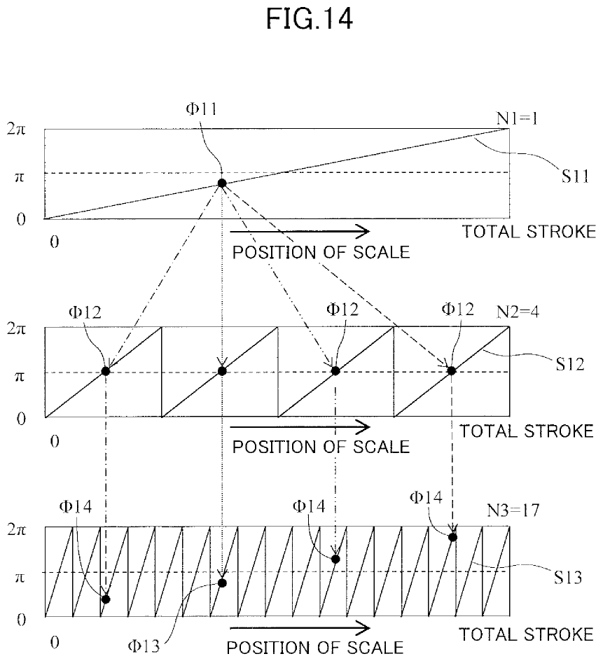

FIG. 14 is a diagram for describing a position detection method according the third exemplary embodiment. FIG. 14 illustrates respective relationships of the phase values Φ11, Φ12, and Φ13 with the position of the scale 2B. In the example of FIG. 14, a case of correct synchronization and a case of incorrect synchronization between the upper signal S11 and the middle signal S12 are illustrated. For example, in the case of incorrect synchronization, synchronization is performed with a cycle deviated by one cycle or two cycles from the correct cycle. The case of correct synchronization is indicated by dotted lines, the case where synchronization is performed with a cycle deviated by one cycle from the correct cycle is indicated by one-dot chain lines and two-dot chain lines, and the case where synchronization is performed with a cycle deviated by two cycles from the correct cycle is indicated by broken lines. In the case where a foreign matter or a scratch is on the scale 2B, incorrect synchronization is sometimes performed between the upper signal S11 and the middle signal S12.

For example, in the case where the phase value Φ11 has shifted due to a foreign matter or the like, sometimes the signal processing circuit 51 may select the first cycle, the third cycle, or the fourth cycle in the synchronization processing between the upper signal S11 and the middle signal S12 in step S202. As described above, in the case where the synchronization is incorrect, the phase value Φ14 which is 0.4π, 1.47π, or 1.97π in this case, is deviated from the phase value Φ13, which is 0.97c in this case, beyond the predetermined range R. In the actuality, since a small error occurs in the phase value Φ13 of the lower signal S13 due to a pattern error of the scale 2B, an interpolation error derived from high-frequency waves or the like, superimposition of a noise, or the like, the value of the predetermined range R is set in consideration of the error. In the present exemplary embodiment, in the case where the difference ΔΦ is out of the predetermined range R, that is, in the case where the result of step S205 is NO, the signal processing circuit 51 reselects a cycle in the cycles of the cycle number N3 in the lower signal S13 in step S208, and obtains the absolute position information of the position of the scale 2B in step S206. Then, the signal processing circuit 51 outputs the obtained absolute position information to an external device in step S207.

Processing of step S208 will be described. In the case where the difference ΔΦ is out of the predetermined range R, the signal processing circuit 51 selects, on the basis of the difference ΔΦ, that is, on the basis of the relationship between the phase values Φ13 and Φ14 and from the cycles of the cycle number N3, a cycle different from the cycle already selected from the cycles of the cycle number N3.

The processing of step S208 will be described in detail. First, in the case where the difference ΔΦ is out of the predetermined range R, the signal processing circuit 51 selects, from the cycles of the cycle number N2, a cycle different from the cycle already selected from the cycles of the cycle number N2. For example, the signal processing circuit 51 selects a cycle whose difference ΔΦ is the smallest on the basis of the plus/minus sign and magnitude of the difference ΔΦ obtained in step S205. A specific example will be given for description. First, a case where the third cycle in the cycles of the cycle number N2 has been already selected is assumed. The signal processing circuit 51 selects, from the remaining first, second, and fourth cycles in the middle signal S12, the cycle whose difference ΔΦ is the smallest, that is, the second cycle. The signal processing circuit 51 selects, from the cycles of the cycle number N3 in the lower signal S13, a different cycle corresponding to the phase value Φ12 of the different selected cycle, that is, the second cycle, of the cycles of the cycle number N2. The cycle selected herein is the seventh cycle in FIG. 14.

In step S206, the signal processing circuit 51 obtains the position of the scale 2B on the basis of the different selected cycle, that is, the seventh cycle, of the cycles of the cycle number N3, and the phase value Φ13.

As described above, in the third exemplary embodiment, whether or not the synchronization between the upper signal S11 and the middle signal S12 is incorrect can be determined. In the case where the phase value Φ14 of the lower signal S13 is deviated from the phase value Φ13, it is determined that the synchronization between the upper signal S11 and the middle signal S12 is incorrect. The phase value Φ14 obtained as a result of the evaluation of the synchronization between the upper signal S11 and the middle signal S12 is different in each case, for example, 0.4π, 0.9π, 1.4π, or 1.9π. Therefore, by evaluating this value, the correct synchronization relationship between the upper signal S11 and the middle signal S12 can be calculated. Further, in the case where the synchronization is incorrect, the synchronization relationship can be corrected to calculate accurate absolute position information of the scale 2B.

According to the third exemplary embodiment, since the synchronization evaluation by the signal processing circuit 51 in step S205 of FIG. 12 is performed on the basis of the phase values Φ11, Φ12, and Φ13 obtained at the time of position detection, time required for position detection can be shortened while also performing the synchronization evaluation. Therefore, in an apparatus that controls a control target object on the basis of detected position information, time required for control can be shortened.

To be noted, the synchronization relationship between the upper signal S11 and the middle signal S12 may be also checked by evaluating the accuracy of synchronization between the middle signal S12 and the lower signal S13 on the basis of the phase value Φ13 of the lower signal S13. In addition, although a case where the cycle number N1 of the upper signal S11 is 1, the cycle number N2 of the middle signal S12 is 4, and the cycle number N3 of the lower signal S13 is 17 in the total stroke of the scale 2B has been described, these values are not limited to these examples.

It is preferable that the value N3/N2 obtained by dividing the cycle number N3 of the lower signal S13 by the cycle number N2 of the middle signal S12 is a value with a non-zero fraction part. In addition, a value obtained by multiplying the fraction part of the value N3/N2 by a value N2/N1 obtained by dividing the cycle number N2 by the cycle number N1 will be referred to as NN. It is preferable that the value NN is a natural number that is not a multiple of a divider of the value N2/N1 excluding 1 and is smaller than the value N2/N1.

In the example described above, N3/N2 is 17/4=4.25, which is a value with a non-zero fraction part. The fraction part of the value with a non-zero fraction part is 0.25. N2/N1 is 4. NN is 0.25×4=1. Natural numbers that are not multiples of dividers of the value N2/N1 excluding 1 are 1 and 3. Natural numbers smaller than N2/N1 are 1, 2, and 3. That is, natural numbers that are not multiples of dividers of the value N2/N1 excluding 1 and are smaller than the value N2/N1 are 1 and 3. Therefore, NN may be 1 or 3, and is 1 in the example described above. In this case, since the cycle number N2 is 4, there are four different candidates of the phase value Φ14 as illustrated in FIGS. 13 and 14. That is, since the candidates are not equal, the accuracy of the synchronization evaluation in step S205 is improved, and thus the detection accuracy of the position of the scale 2B is improved.

According to the numerical relationship described above, a value obtained by converting the phase value Φ12 into a phase value corresponding to the lower signal S13 for all cycles in the middle signal S12 in accordance with the ordinal number of the cycle. Therefore, the synchronization relationship between the upper signal S11 and the middle signal S12 can be accurately corrected, and as a result, the accurate position of the scale 2B can be obtained.

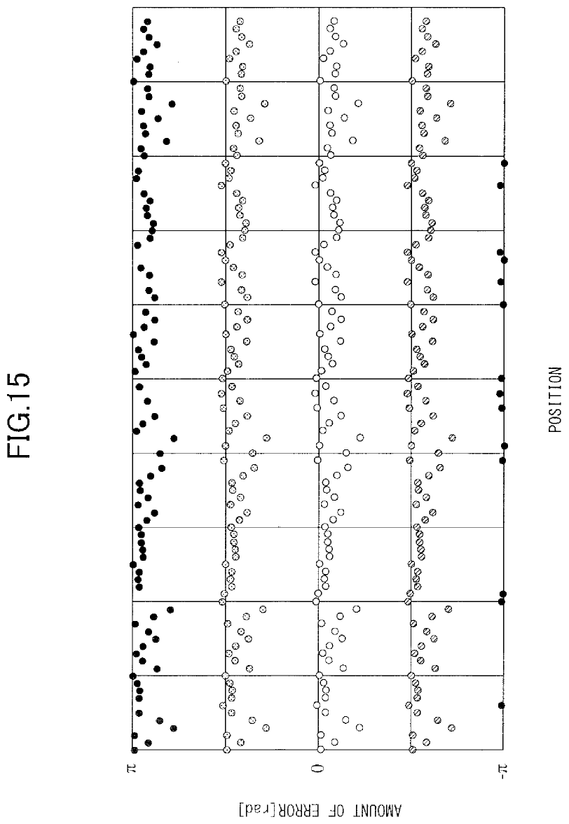

FIG. 15 is a graph showing experimental results of the third exemplary embodiment. FIG. 15 shows an example of position information actually measured without correcting the synchronization relationship. In FIG. 15, the horizontal axis represents the position of the scale 2B, and the vertical axis represents an amount of error in the phase information. As illustrated in FIG. 15, regardless of whether or not the synchronization between the upper signal and the middle signal is incorrect, there is a small error, or variation, in the phase value of the lower signal due to the pattern error of the scale 2B, interpolation error derived from high-frequency waves, and superimposed noises. As illustrated in FIG. 15, in the case where the synchronization between the upper signal and the middle signal is not incorrect, the amount of error of the phase value Φ14 of the lower signal is close to 0 [rad]. In FIG. 15, values distributed near 0 [rad] are illustrated as hollow circles. In the case where the synchronization is incorrect, the amount of error has an offset larger than a predetermined amount with respect to 0 [rad]. In the example of FIG. 15, the amount of error of the phase value Φ14 has a value near −π/2 [rad], +π/2 [rad], +π [rad], or −π [rad]. In FIG. 15, values distributed near +π [rad] and −π [rad] are illustrated as solid circles. Values distributed near +π/2 [rad] and values distributed near −π/2 [rad] are respectively illustrated as circles with different hatching.

In the case where the synchronization between the upper signal and the middle signal is incorrect, correct synchronization relationship can be calculated by searching for a value with which the amount of error of the phase value of the lower signal is within the predetermined range R by changing the synchronization relationship between the upper signal and the middle signal by calculation. The predetermined range R is, for example, a range of 0±π/4 [rad].

Although the relationship between the three periodic signals of the upper signal, middle signal, and lower signal has been described in the third exemplary embodiment, the configuration is not limited to this. The present disclosure can be applied to a case where three or more periodic signals having different cycle numbers are obtained. That is, the processing described in the third exemplary embodiment may be performed on three consecutive periodic signals having a relationship of upper, middle, and lower signals among the three or more periodic signals. In this case, whether or not the synchronization between the upper periodic signal and the middle periodic signal is incorrect can be determined by evaluating the phase value of the lower periodic signal. As described above, in an absolute encoder that obtains absolute position information, whether or not the synchronization between the middle periodic signal and higher periodic signal is incorrect can be confirmed by evaluating the phase value of the lower periodic signal in the three periodic signals. Further, the synchronization relationship can be corrected to obtain accurate absolute position information.

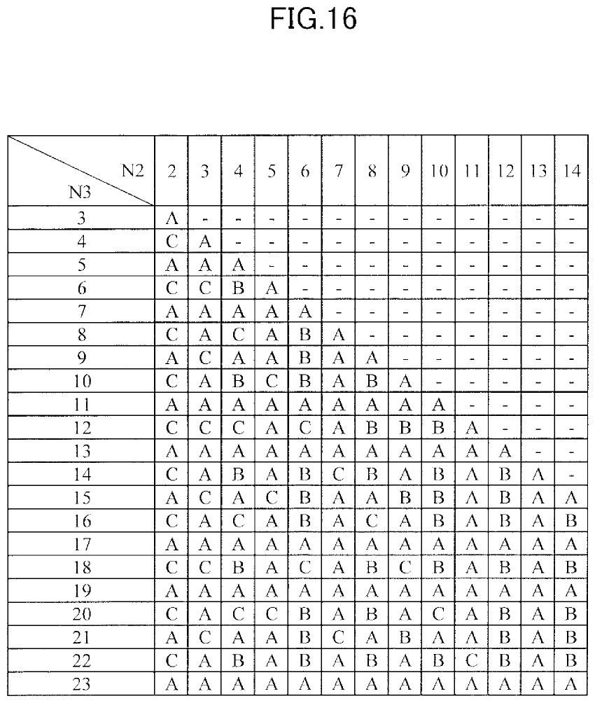

FIG. 16 is a diagram illustrating applicability corresponding to cycle numbers. It is assumed that the cycle number N1 is 1. The applicability is shown with the horizontal axis representing the cycle number N2 and the vertical axis representing the cycle number N3. In FIG. 16, cases where the cycle number N2 is 2 to 14 and the cycle number N3 is 3 to 23 are shown.

In FIG. 16, “A” indicates an example suitable for the first to third exemplary embodiments, “B” indicates an example suitable for the first and second exemplary embodiments, “C” indicates a case not corresponding to either of “A” and “B”, and “-” indicates a case where N2>N3 holds, which is inappropriate for a configuration of an absolute encoder. To be noted, the example of the first exemplary embodiment described above corresponds to the case where the cycle number N2 is 4 and the cycle number N3 is 18. The example of the third exemplary embodiment described above corresponds to the case where the cycle number N2 is 4 and the cycle number N3 is 17.

### Fourth Exemplary Embodiment

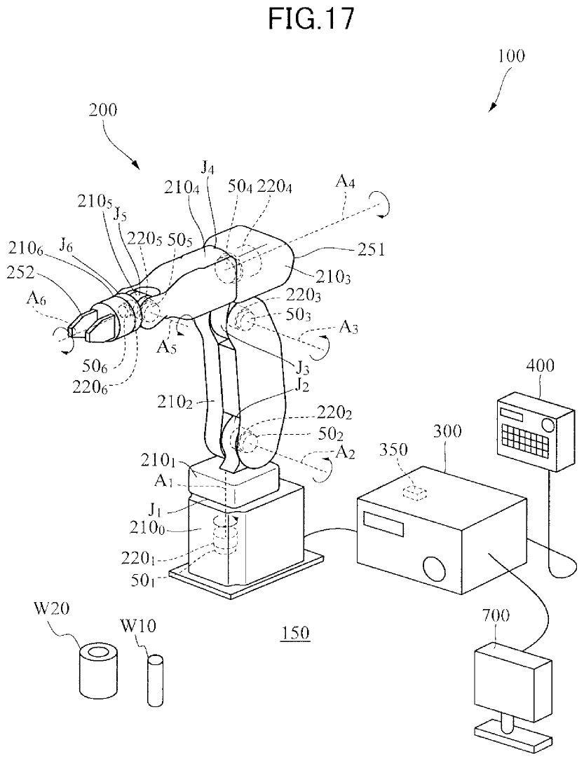

In a fourth exemplary embodiment, a case where the encoder of any one of the first to third exemplary embodiments described above is incorporated in a robot arm will be described. FIG. 17 is a perspective view of a robot apparatus 100 according to the fourth exemplary embodiment. As illustrated in FIG. 17, the robot apparatus 100 includes a robot 200 serving as a manipulator, and a robot control apparatus 300 that serves as an example of a controller and controls the operation of the robot 200. The robot apparatus 100 includes a teaching pendant 400 serving as a teaching apparatus that transmits teaching data to the robot control apparatus 300, and a display 700 serving as a display apparatus. The teaching pendant 400 is operated by an operator, and is used for instructing an operation to the robot 200 and the robot control apparatus 300.

The robot 200 includes a robot arm 251, and a robot hand 252 serving as an example of an end effector provided on a distal end of the robot arm 251. The proximal end of the robot arm 251 is fixed to a stage 150. The robot hand 252 grips an object such as a part or a tool serving as a workpiece.

The robot arm 251 is, for example, a vertically articulated robot arm, and includes a plurality of joints, for example, six joints J₁ to J₆. The robot arm 251 includes electric motors 220₁ to 220₆ serving as examples of driving portions that respectively rotationally drive the joints J₁ to J₆ about joint shafts A₁ to A₆.

The robot arm 251 includes a plurality of links 210₀ to 210₆ rotationally interconnected via the joints J₁ to J₆. In the fourth exemplary embodiment, the links 210₀ to 210₆ are interconnected in series in this order from the proximal end side to the distal end side. The robot arm 251 is capable of moving the distal end of the robot arm 251, that is, the robot hand 252 to an arbitrary position within a movable range. To be noted, although a case where the joints of the robot arm 251 are rotary joints will be described, the joints may be linear motion joints. A “position of a joint” refers to the rotational position, in other words, the angle, or a translational position of the joint.

In addition, the robot arm 251 includes encoders 50₁ to 50₆ respectively disposed in the joints J₁ to J₆. The encoders 50₁ to 50₆ are each an optical rotary encoder. The encoders 50₁ to 50₆ each have a configuration similar to that of the encoder described above in the first or second exemplary embodiment, and respectively output position information, that is, the angle information of the joints J₁ to J₆.

The robot control apparatus 300 is connected to a servo control apparatus 350 serving as a drive control portion that operates the electric motors 220₁ to 220₆. The servo control apparatus 350 outputs, on the basis of a position instruction corresponding to the joints J₁ to J₆, current to the respective electric motors 220₁ to 220₆ to control the electric motors 220₁ to 220₆ such that the positions of the joints J₁ to J₆ follow the position instruction. To be noted, although the servo control apparatus 350 is disposed inside the robot control apparatus 300 in the fourth exemplary embodiment, the configuration is not limited to this. The servo control apparatus 350 may be disposed outside the robot control apparatus 300, for example, inside the robot arm 251.

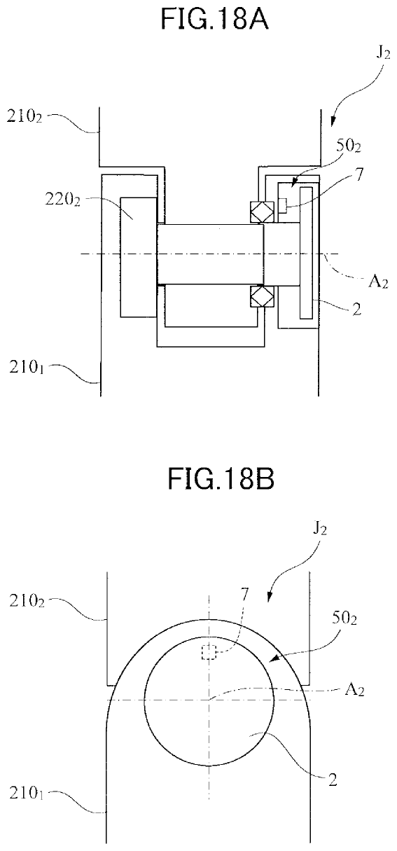

FIG. 18A is a section view of the joint J₂ of the robot arm 251. FIG. 18B is a side view of the joint J₂ of the robot arm 251. Hereinafter, the configuration of the joint J₂ of the robot arm 251 will be described. Since the joints J₁ and J₃ to J₆ have the same configuration as the joint J₂, description of the configurations of the joints J₁ and J₃ to J₆ will be omitted.

The link 210₁ serving as an example of a first link and the link 210₂ serving as an example of a second link are interconnected via the joint J₂, and the link 210₂ relatively rotationally moves about a rotation axis A₂ with respect to the link 210₁ at the joint J₂.

The electric motor 220₂ serving as an example of a driving portion is disposed in the joint J₂ so as to rotationally drive the link 210₂ with respect to the link 210₁. In addition, the encoder 50₂ that detects the rotation angle corresponding to the position of the link 210₂ with respect to the link 210₁ is disposed in the joint J₂. The sensor unit 7 of the encoder 50₂ is provided in one of the links 210₁ and 210₂, for example, in the link 210₁. The scale 2 of the encoder 50₂ is provided in the other of the links 210₁ and 210₂, for example, in the link 210₂.

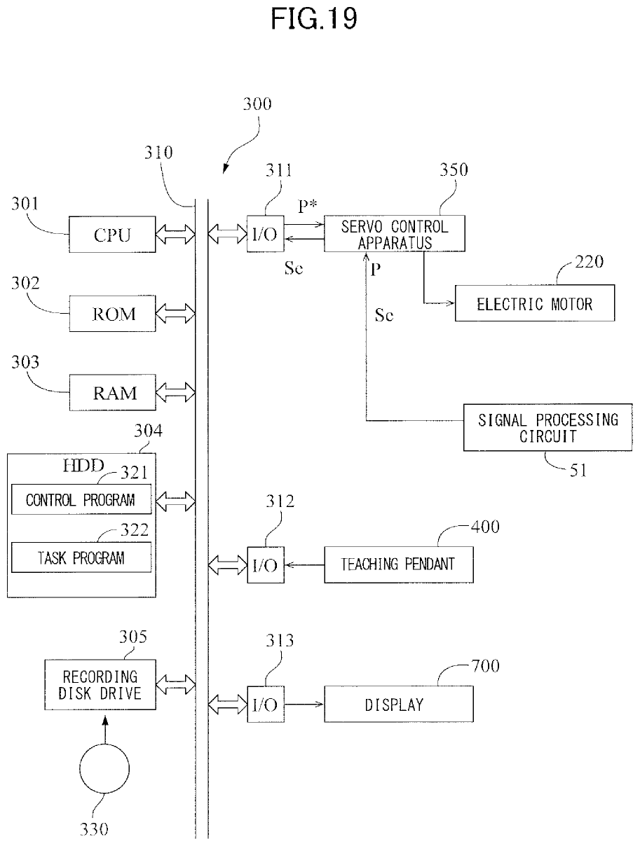

FIG. 19 is a block diagram illustrating a control system of the robot apparatus 100 according to the fourth exemplary embodiment. The robot control apparatus 300 is constituted by a computer. The robot control apparatus 300 includes a CPU 301. In addition, the robot control apparatus 300 includes a ROM 302, a RAM 303, and a hard disk drive: HDD 304 serving as examples of a storage portion. In addition, the robot control apparatus 300 includes a recording disk drive 305 and I/O 311 to 313 that are input/output interfaces.

The CPU 301, the ROM 302, the RAM 303, the HDD 304, the recording disk drive 305, and the I/O 311 to 313 are communicably interconnected via a bus 310. The I/O 311 is connected to the servo control apparatus 350, the I/O 312 is connected to the teaching pendant 400, and the I/O 313 is connected to the display 700.

The servo control apparatus 350 is connected to the electric motor 220 of each of the joints J₁ to J₆ and to the signal processing circuit 51. To be noted, although the electric motor 220 and the signal processing circuit 51 for one joint are illustrated in FIG. 3, the servo control apparatus 350 is connected to electric motors 220 and signal processing circuits 51 for six joints.

The CPU 301 controls the operation of each electric motor 220 that drives each of the joints J₁ to J₆ of the robot 200 via the servo control apparatus 350, and thus controls the operation of the robot 200. In addition, the CPU 301 receives an instruction transmitted from the teaching pendant 400 by an operation by an operator. Further, the CPU 301 controls the display 700 to display an image on the display 700.

The HDD 304 stores a control program 321 and a task program 322. The recording disk drive 305 is capable of reading out various data, programs, and the like recorded in a recording disk 330.

The control program 321 is a program that causes the CPU 301 to interpret the task program 322, generate trajectory data of the robot arm 251, and perform various calculation and control. The control program 321 is configured so as not to be easily modified by a user. The task program 322 is, for example, a text file described in a robot language, and can be modified by a user or a computer. The CPU 301 loads the task program 322, generates trajectory data connecting teaching points by a predetermined interpolation method, for example, linear interpolation or circular interpolation, and stores the generated trajectory data in the HDD 304. In the case of the linear interpolation, trajectory data for linearly moving the distal end of the robot arm 251 is generated. The CPU 301 converts data of each point in the trajectory data into the rotation angle of each of the joints J₁ to J₆ by inverse kinematic calculation of the robot, and outputs a position instruction P* to the servo control apparatus 350.

The signal processing circuit 51 of the encoder apparatus outputs a signal indicating position information P of the joint to the servo control apparatus 350. The servo control apparatus 350 controls the current supplied to the electric motor 220 such that the position information P obtained from the signal processing circuit 51 matches the position instruction P*. According to the feedback control described above, the robot control apparatus 300 causes the robot arm 251 to operate in accordance with the trajectory data.

The robot 200 is disposed in a manufacture line. The robot 200 is caused to perform a predetermined operation for manufacturing a product, for example, an operation of fitting a workpiece W10 illustrated in FIG. 17 serving as a first workpiece into a workpiece W20 serving as a second workpiece. Specifically, the robot control apparatus 300 controls the robot 200 to cause the robot hand 252 to grip the workpiece W10, and the workpiece W10 is fit into the workpiece W20 by moving the robot hand 252 gripping the workpiece W10 toward the workpiece W20.

Incidentally, a small gap is provided in a joint of the robot arm 251, that is, between a pair of links, for driving one of the links with respect to the other. There is a possibility that foreign matter or grease enters this gap and attaches to the scale 2.

In the fourth exemplary embodiment, the signal processing circuit 51 outputs an error signal Se to the servo control apparatus 350 as processing of step S108 illustrated in FIG. 6 and described in the first exemplary embodiment. In the case where the robot control apparatus 300 has received input of the error signal Se from the signal processing circuit 51 via the servo control apparatus 350, the robot control apparatus 300 performs control to stop the operation of the robot arm 251, that is, the operation of the robot 200. To be noted, the signal processing circuit 51 may directly output the error signal Se to the robot control apparatus 300 without outputting the error signal Se to the servo control apparatus 350.

In the case where the robot control apparatus 300 has received input of the error signal Se, the robot control apparatus 300 may cause the display 700 to display an image corresponding to the error signal Se. According to this, a user can recognize that an abnormality has occurred in the robot arm 251, that is, an abnormality has occurred in the encoder 50, by referring to the display 700. In the case where the synchronization is not incorrect, since the signal processing circuit 51 does not output the error signal Se, the robot control apparatus 300 continues controlling the robot arm 251, that is, controlling the robot 200.

As described above, according to the fourth exemplary embodiment, the robot arm 251 is caused to operate on the basis of position information output as a result of the synchronization evaluation performed by the signal processing circuit 51, and therefore the time required for control of the robot arm 251, that is, time required for control of the robot 200 can be shortened.

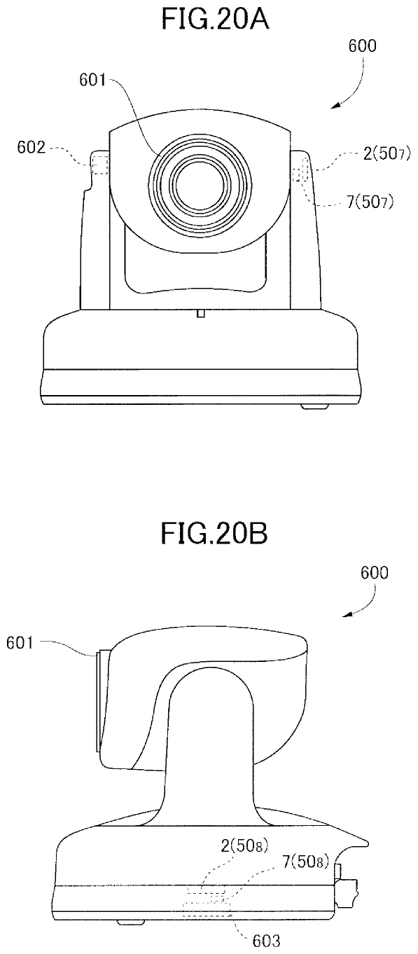

To be noted, although a case where the encoder apparatus 500 of the first exemplary embodiment described above is applied to the robot apparatus 100 has been described in the fourth exemplary embodiment, the encoder apparatus can be also applied to various devices other than robots. For example, as illustrated in FIGS. 20A and 20B, the present disclosure can be applied to encoders 50₇ and 50₈ that detect the rotation angle of a lens barrel 601 serving as an optical unit of a surveillance camera 600 including a driving mechanism for the horizontal direction, that is, a pan direction, and the vertical direction, that is, a tilt direction. That is, in the surveillance camera 600 serving as an optical device, an electric motor 603 that horizontally rotates the lens barrel 601 and an electric motor 602 that vertically rotates the lens barrel 601 constitute a driving mechanism that drives an optical unit. Further, scales 2 configured to respectively rotate together with driving shafts of the electric motors 603 and 602 and sensor units 7 including light receiving elements that detect light reflected on the scales 2 constitute the encoders 50₇ and 50₈ that detect the position of the optical unit. The robot control apparatus 300 executes the same control method also in the case where the encoder apparatus 500A of the second exemplary embodiment described above is applied to the robot apparatus 100.

In addition, in the case where the encoder apparatus of the third exemplary embodiment described above is applied to the robot apparatus 100, the signal processing circuit 51 corrects the incorrect synchronization and outputs highly accurate absolute position information to the servo control apparatus 350.

The present invention is not limited to the exemplary embodiments described above, and can be modified in many ways within the technical concept of the present invention. In addition, effects described in the exemplary embodiments are merely enumeration of most preferable effects that can be achieved by the present disclosure, and the effects of the present disclosure are not limited to the examples described in the exemplary embodiments.

Although a case where the encoder is of a reflection type has been described in the first to fourth exemplary embodiments, the configuration is not limited to this. For example, the encoder may be of a transmission type. In addition, the encoder is not limited to an optical encoder, and may be, for example, a magnetic encoder or an electrostatic capacitance encoder. Further, the encoder is not limited to a linear encoder, and may be a rotary encoder. In the case where the encoder is a rotary encoder, a rotational position is detected as the absolute position information.

Although a case where the scale has two pattern rows having different pitches, or different periods, has been described in the first to third exemplary embodiments, the scale may have three or more pattern rows having different pitches. In this case, the signal processing circuit may obtain a Vernier signal from one of the plurality of pattern rows.

Although a vertically articulated robot arm has been described in the fourth exemplary embodiment, the configuration is not limited to this. The encoder can be applied to various robot arms such as horizontally articulated robot arms, parallel link robot arms, and orthogonal robots.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-020133, filed Feb. 6, 2019 and Japanese Patent Application No. 2019-221663, filed Dec. 6, 2019, which are hereby incorporated by reference herein in their entirety.

What is claimed is:

1. A position detection method for a scale, the position detection method comprising:
obtaining, by a processor and at the same position of the scale, a first phase value of a first signal that repetitively changes by a first cycle number per predetermined displacement of the scale, a second phase value of a second signal that repetitively changes by a second cycle number larger than the first cycle number per the predetermined displacement of the scale, and a third phase value of a third signal that repetitively changes by a third cycle number larger than the second cycle number per the predetermined displacement of the scale;
selecting, by the processor, one cycle corresponding to the first phase value from cycles of the second cycle number in the second signal;
selecting, by the processor and from cycles of the third cycle number in the third signal, one cycle corresponding to the second phase value and the cycle selected from the cycles of the second cycle number;
obtaining, by the processor, a fourth phase value of the third signal corresponding to the second phase value of the cycle selected from the cycles of the second cycle number; and
obtaining, by the processor, a position of the scale by using the third phase value and the fourth phase value.

2. The position detection method according to claim 1, further comprising obtaining, by the processor, a difference between the third phase value and the fourth phase value.

3. The position detection method according to claim 2, wherein, in a case where the difference between the third phase value and the fourth phase value is within a predetermined range, the processor obtains the position of the scale on a basis of the third phase value and the cycle selected from the cycles of the third cycle number.

4. The position detection method according to claim 3, wherein, in a case where the difference is out of the predetermined range, the processor outputs an error signal.

5. The position detection method according to claim 3,
wherein, in a case where the difference is out of the predetermined range, the processor selects, on a basis of a relationship between the third phase value and the fourth phase value and from the cycles of the third cycle number, one cycle different from the cycle already selected from the cycles of the third cycle number, and
wherein the processor obtains the position of the scale on a basis of the third phase value and the different cycle selected from the cycles of the third cycle number.

6. The position detection method according to claim 1, wherein a value N3/N2 obtained by dividing the third cycle number by the second cycle number is a non-integer value.

7. The position detection method according to claim 5,
wherein a value N3/N2 obtained by dividing the third cycle number by the second cycle number is a non-integer value, and
wherein a value NN obtained by multiplying a fraction part of the value N3/N2 by a value N2/N1 obtained by dividing the second cycle number by the first cycle number is a natural number that is different from a multiple of a divider of the value N2/N1 excluding 1 and is smaller than the value N2/N1.

8. The position detection method according to claim 1, wherein the processor obtains the first phase value from the second phase value and the third phase value by Veinier operation.

9. A control method for a robot comprising a first link and a second link configured to rotate with respect to the first link, the control method comprising:
controlling the robot by detecting, by the position detection method according to claim 1, a position of the second link that rotates with respect to the first link.

10. A control method for a robot comprising a first link and a second link configured to rotate with respect to the first link, the control method comprising:
controlling the robot by detecting, by the position detection method according to claim 4, a position of the second link that rotates with respect to the first link; and
stopping operation of the robot in a case where the error signal is output.

11. A manufacturing method for a product, the manufacturing method comprising operating the robot by the control method according to claim 9 to manufacture a product.

12. A position detection apparatus comprising:
a processor;
a scale; and
a detection portion configured to output a signal corresponding to a position of the scale to the processor,
wherein the processor
obtains, at the same position of the scale, a first phase value of a first signal that repetitively changes by a first cycle number per predetermined displacement of the scale, a second phase value of a second signal that repetitively changes by a second cycle number larger than the first cycle number per the predetermined displacement of the scale, and a third phase value of a third signal that repetitively changes by a third cycle number larger than the second cycle number per the predetermined displacement of the scale,
selects, from cycles of the second cycle number in the second signal, one cycle corresponding to the first phase value, and, from cycles of the third cycle number in the third signal, one cycle corresponding to the second phase value and the cycle selected from the cycles of the second cycle number,
obtains a fourth phase value of the third signal corresponding to the second phase value of the cycle selected from the cycles of the second cycle number, and
obtains the position of the scale on a basis of the third phase value and the fourth phase value.

13. The position detection apparatus according to claim 12, wherein the processor obtains a difference between the third phase value and the fourth phase value.

14. The position detection apparatus according to claim 13, wherein, in a case where the difference between the third phase value and the fourth phase value is within a predetermined range, the processor obtains the position of the scale on a basis of the third phase value and the cycle selected from the cycles of the third cycle number.

15. A robot apparatus comprising:
a first link;
a second link configured to relatively rotate with respect to the first link; and
the position detection apparatus according to claim 12 configured to detect a position of the second link that rotates with respect to the first link.

16. An optical device comprising:
a driving mechanism configured to drive an optical unit; and
the position detection apparatus according to claim 12 configured to detect a position of the optical unit.

17. A non-transitory computer-readable recording medium storing a program for causing a computer to execute the position detection method according to claim 1.
